(19) United States
(12) Patent Application Publication
(10) Pub. No.: US 2019/0171653 A1
(43) Pub. Date: Jun. 6, 2019

(54) METHOD OF AUTOMATING AND CREATING CHALLENGES, CALLS TO ACTION, INTERVIEWS, AND QUESTIONS

(71) Applicants: Amy Balderson Junod, Versoix (CH); David C. Beck, Carefree, AZ (US); Bonnie Fatio, Geneva (CH)

(72) Inventors: Amy Balderson Junod, Versoix (CH); David C. Beck, Carefree, AZ (US); Bonnie Fatio, Geneva (CH)

(21) Appl. No.: 16/178,763

(22) Filed: Nov. 2, 2018

Related U.S. Application Data
(63) Continuation-in-part of application No. 16/037,772, filed on Jul. 17, 2018, now abandoned.
(60) Provisional application No. 62/533,234, filed on Jul. 17, 2017.

(51) Int. Cl. G06F 16/28; G06F 16/332; G06F 16/738; G06F 16/955; G06Q 50/00

(52) U.S. Cl. CPC G06F 16/287; G06F 16/3326; G06Q 50/01; G06F 16/9566; G06F 16/739

(57) ABSTRACT

Disclosed herein are systems and methods for sourcing content and systems and methods for providing interactive collaboration over a computer network. An example method includes enabling a user to deposit content by a subject person in connection with a given topic, and enabling the user to tailor parameters associated with distribution of the content. The parameters include at least an identifier of the subject person in the content and a distribution control indicator selectable to a given number of states, including a zero-distribution state. The method further includes enabling another user to access the content via a content collection and distribution channel by selection of the given topic or a different topic linked to the given topic, and facilitating distribution, disablement, or retraction of the content via the content collection and distribution channel as a function of at least the distribution control indicator.

### RELATED APPLICATIONS

This application is a continuation-in-part of U.S. application Ser. No. 16/037,772, filed Jul. 17, 2018, which claims the benefit of U.S. Provisional Application No. 62/533,234, filed on Jul. 17, 2017. The entire teachings of the above application are incorporated herein by reference.

### BACKGROUND

Legacy discussions, presentations, and interviews have become popular methods in the historical present field. Having the ability to capture real-time thinking, including their moral compass, life purpose and values, of soon-to-be historical figures is the best means to accurately gauge their thoughts at that time.

In the industry of interviewing, many recruitment companies use asynchronous interviews to sort through masses of candidates. In academia, education mooks and other online academic solutions use video as a tool among many in the online education process.

Digital technology, has allowed legacy interviews to be easily recorded, stored, and distributed broadly. Interviews are able to be held at the location of the prominent figure, in comparison to the prominent figure coming to a studio or the like. Over time, more interviews are able to be conducted more quickly, wherever the user may be located and allows them to be stored indefinitely at multiple locations. Digital storage of interviews has also made them more easily accessible over a network, and viewable by multiple people.

However, even considering improvements in the technology around interviews, the field lacks the ability to make interviews culturally and emotionally sensitive. Through improved automated technology, more users, can participate in interviews. For example, different users may prefer to answer different interview questions. Also, cultural differences may cause different interviewees to answer interview questions in a variety of ways. For example, body language in many Western countries nod their heads up and down to indicate affirmation (“yes”), whereas in Eastern countries such as India, the gesture for affirmation is a bobbling movement of the head from right to left.

### SUMMARY

The embodiments presented herein relate to automating and creating interview questions that allows an interviewee to control his or her interview by managing the creation of and responses to audio-visual and free-text questions, themes and interviews, documents, photographs and other media both in real time and offline.

To accommodate diverse types of users, including prominent figures, there is a need for methods and systems that allow the creation and adjustment of interview questions suitable for each individual based on their individual needs.

A more effective approach and procedure are required for modeling reflective practices that lead to yield a more accurate analysis, and better results for individual end-users. Accordingly, the limitations and disadvantages of the existing procedures known in the art are overcome with the embodiments presented herein, which provide improved means and techniques for more effective instruction and compelling content.

The embodiments presented herein provide systems and methods for enabling an interviewee to control his or her interview through management of the resultant interview, which includes managing the creation of and responses to asynchronous audio-visual and written questions, themes, interviews, documents, photographs and other media, both in real time online and post-interview off-line. For example, the interviewee can have the ability to control all thematic content associated with his or her interview and may determine the timing of release, audiences, and location of meta-data and storage.

The embodiments presented herein enable the automation of responses from the automated interviewer including (1) recording the video, (2) creating meta-data, and (3) enabling the modification of the means and types of interview questions based upon feedback cues received from the interviewee during the interview. Such feedback cues can include but are not limited to interviewee gestures, tone of voice, spoken words, and body language, and they can encompass future types of interne technology and artificial intelligence.

One example embodiment is a method of sourcing content. The example method includes enabling a user to create or deposit content by a subject person in connection with a given topic, and enabling the user to tailor parameters associated with distribution of the content. The parameters include at least an identifier of the subject person in the content and a distribution control indicator selectable to a given number of states, including a zero-distribution state. The method further includes enabling one or more other users to access and contribute to the content via a content collection and distribution channel by selection of the given topic or a different topic linked to the given topic, and facilitating distribution, disablement, or retraction of the content via the distribution channel as a function of at least the distribution control indicator. For example, a user may restrict specific content for release upon his or her death, and limit viewership to a specific group of individuals.

The parameters can be stored separately from the content and the content can be replicated across multiple content collection and distribution channels, apps, widgets as a function of the distribution control indicator. In such a case, the example method can further enable the user or subject person to modify the distribution control indicator to restrict further distribution to a subset of the multiple distribution channels or to disable or retract the content from one or more of the multiple distribution channels.

The content collection and distribution channel can include a user-created relational database (or via other future means) accessible by the other users. In such a case, the example method can further include enabling a user or database manager to import the topic or define a related topic in the relational database in a manner that relates the content to the topic or related topic. The topic or related topic can be a question or related inquiries, and the content can be a video clip or multiple video clips that are associated with the inquiries based on a relationship with at least one inquiry. The parameters can include metadata through which the relational database creates the associations.

In some embodiments, enabling a user to create or deposit content can include duplicating the content at multiple datastore locations. Enabling the user to tailor parameters associated with distribution of the content can include enabling the user to assign current and/or future ownership of the content. For example, prior to or upon death of the user, instructions can be provided regarding ownership and distribution of the content after death of the user.

In some embodiments, enabling users to access and contribute to the content can include providing one or more universal resource locator (URL) links to website(s) associated with a datastore for the content, or embedding code on a website that is remote from the datastore. Enabling users to access and contribute to the content can include challenging the one or more users to provide input regarding the topic. Enabling users to access and contribute to the content can include engaging other users by sharing questions or themed challenges, for example, on social media.

The example method can further include analyzing amalgamated metadata based on the content created and deposited by one or more users, where amalgamated metadata includes at least a topic identification or trending themes.

Another example embodiment is a system for providing interactive collaboration over a computer network. The example system includes a content database, an organizational database, an interface, and a processor. The content database is configured to store digital content created by users. The organizational database is configured to store representations of relationships between the digital content stored in the content database and the users. The interface is configured to provide access to the digital content by other users and to enable the other users to provide feedback related to the digital content in a similar format as the digital content. The processor is in communication with the databases and the interface and configured to implement an intermediary layer between the databases and the interface. The intermediary layer is configured to control which users can access the digital content, to store the feedback from the other users in the database in a manner that is associated with the original digital content, and to provide users with controlled access to the feedback. A user accessing the content can be enabled to provide feedback in the form of video, text, or other media.

The system can further include a server hosting the databases and the interface, and the interface can include a website accessible by a uniform resource locator (URL) link. Alternatively, or in addition to the URL interface, the interface can include embedded code on one or more websites that are remote from the databases. Further, the interface can include embedded code on one or more websites that are not visible on the URL, but accessible through an Administrator Dashboard or user account.

The databases can be relational databases, or other future technological structures for organizing and distributing content. Feedback to the digital content can be stored in the content database and representations of relationships can be stored in the organizational database in a manner associated with the digital content in a parent-child relationship. The representations of relationships can be updated in real time, or asynchronously, simultaneously across each part of the interface. In such an embodiment, the processor can be configured to, when providing the digital content to the interface, access the databases to determine additional digital content that is feedback to the digital content and to provide to the interface the feedback along with the digital content. The interface can be configured to present the digital content to a user along with one or more indications of the feedback.

Another example embodiment is a system for providing thematic interactive collaboration. The example system includes a content database, an organizational database, an interface, and a processor. The content database is configured to store video content created by at least one user. The organizational database configured to store representations of relationships between the digital content stored in the content database and the users. The interface is configured to provide access to the video content by other users and to enable the other users to provide feedback to the video content, where the feedback can be in the form of video, text, or other forms of media. The interface provides access via (i) a uniform resource locator (URL) link to a website associated with the organizational database, which provides information (e.g., identifier tags) used to locate content associated with a specific user and/or content that is stored in the content database, or (ii) embedded code on a website that is remote from the URL. The processor is in communication with the databases and the interface and configured to implement an intermediary layer between the databases and the interface. The intermediary layer is configured to control which users can access the video content, store the video feedback in the database in a parent-child relationship with the video content, and, when providing digital content to the interface, access the databases to determine additional video content that is feedback to the video content.

The interface can be configured to display, in one screen view, video playback of the video content and a plurality of indicators of related videos that have been provided by other users as feedback to the video content. In such an embodiment, the interface can be configured to display video playback of a related video in response to user selection of a corresponding indicator. The interface can be configured to cause the intermediary layer to authenticate a user and to accept new video content from the user as feedback to the video content in response to selection of a reply indicator by the user. If the feedback is greater than a certain amount (e.g., eight replies), the system can display (and play) the replies in succession, displaying in one row a subset of the feedback at any one time, in an order controlled by the user. A default order can be reverse-chronological order. The user may also choose the order depending on a characteristic such as most viewed or other characteristics chosen by the user.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is an example embodiment of a method.

FIG. 2A is an example embodiment of the use of audio processing feedback.

FIG. 2B is an example embodiment of the use of visual processing.

FIG. 3 is an example embodiment of the search within the question database by topic, author, date, keyword, or tailored search.

FIG. 4 is an example embodiment of a method of creating a question by a user.

FIG. 5 is an example embodiment of a user being able to create their own asynchronous interview.

FIG. 6 is an example embodiment wherein an end user edits to their asynchronous interview by allowing existing questions into a video playlist.

FIGS. 7A-D are example embodiments wherein interviews may be created through recording questions in sequence or later organized in a different sequence, or choose from pre-existing questions to create an interview.

FIGS. 8A-B illustrate an example embodiment of the questions database wherein an end-user may choose questions.

FIG. 9 is an alternative embodiment of a method of operation.

FIG. 10 is an example embodiment wherein an interviewee may follow his or her progress through the interview.

FIG. 11 is an example embodiment wherein an interviewee may choose between a variety of thematic interviews to answer.

FIGS. 12A-B are example embodiments wherein a user may create questions and widgets, share them on social media, or embed Q&A widgets anywhere on the internet using a uniquely generated embed code.

FIG. 13 is an example embodiment wherein an embedded widget displays the question and responses.

FIG. 14 is an example embodiment wherein an embedded widget collects, processes, and displays content.

FIG. 15A is an example embodiment wherein a system becomes a user-managed relational audiovisual database. The creation of widgets may be individual (one-to-one interaction), one-to-many, or many-to-many. FIG. 15B is an example embodiment wherein a private Q&A widget can collect content from one person or many. FIG. 15C is an example embodiment wherein complete question series can collect content from one or more persons. The embodiments of FIGS. 15A-C all enable a user to create and tailor user-generated relational databases.

FIG. 16 is an example embodiment wherein public questions may also be used as one-to-one or one-to-many interactions elsewhere on the internet.

FIG. 17 is an example embodiment wherein searchability across the relational database is live across devices.

FIG. 18 is an example embodiment wherein a user's performance may be qualitatively assessed over time.

FIG. 19 illustrates an example embodiment of how a user logs-in to an example platform.

FIG. 20 illustrates an example embodiment of an underlying processes and other aspects of a software system stored in memory.

FIG. 21 illustrates an example embodiment of how users can interact with the master database.

FIG. 22 is a block diagram illustrating a system for providing interactive collaboration over a computer network, according to an example embodiment.

FIG. 23 is a flow diagram illustrating a method of sourcing content, according to an example embodiment.

### DETAILED DESCRIPTION

A description of example embodiments follows.

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

As used herein, the term “prominent figure” refers to an individual, who either publicly or privately, has exercised or exhibited character traits that imbibe admirable characteristics, or who is memorable to someone personally.

As used herein, the term “interview” refers to presenting someone with a question, an inquiry, challenge or call to action, whereupon the person/interviewee responds, usually from their point of view. The “interview” may take the form of one question with multiple answers, multiple questions, inquiries, challenges or calls to action with one or more responses or one or more respondents. In reference to the example embodiments disclosed herein, the presentation of a question to an interviewee is performed by a virtual interviewer, such as questions presented on a computer.

As used herein “widget” refers to an instance of an interview that is accessible to users to view and provide feedback.

As used herein “distribution control indicator” refers to information that is used by the system to control which users can access which content. A distribution and control indicator can be, for example, managed by users and/or by Administrators and Super Administrators. A) Users may create widgets, and content collection and distribution related to widgets may be controlled by users. For example, the user can control the subject theme of the content collected by the widget, and may delete or change the order of content responses and distribution. Individuals may create one or more widgets and each widget is linked to its own content database. Users may be control multiple sets of widgets (sets of tagged content and associated databases) that he or she may place on one or more URLs selected by the user. B) Site Administrators have overall monitoring and control of widget and content placement on and off their own URLs. Site Administrators can control the searchability of users and content. C) Super Administrators have overall monitoring and control of widget and content (collection and distribution) placement on and off all related URLs. For example, a multinational organization may have separate URLs for each country organization and individual brands within each country, each with their own widgets and corresponding databases, linked to the organization's customizable and searchable databases. The multinational organization's Super Administrator may amalgamate all of its content, on and off public URLs to analyze and make improvements to the organization's content collection and distribution strategy.

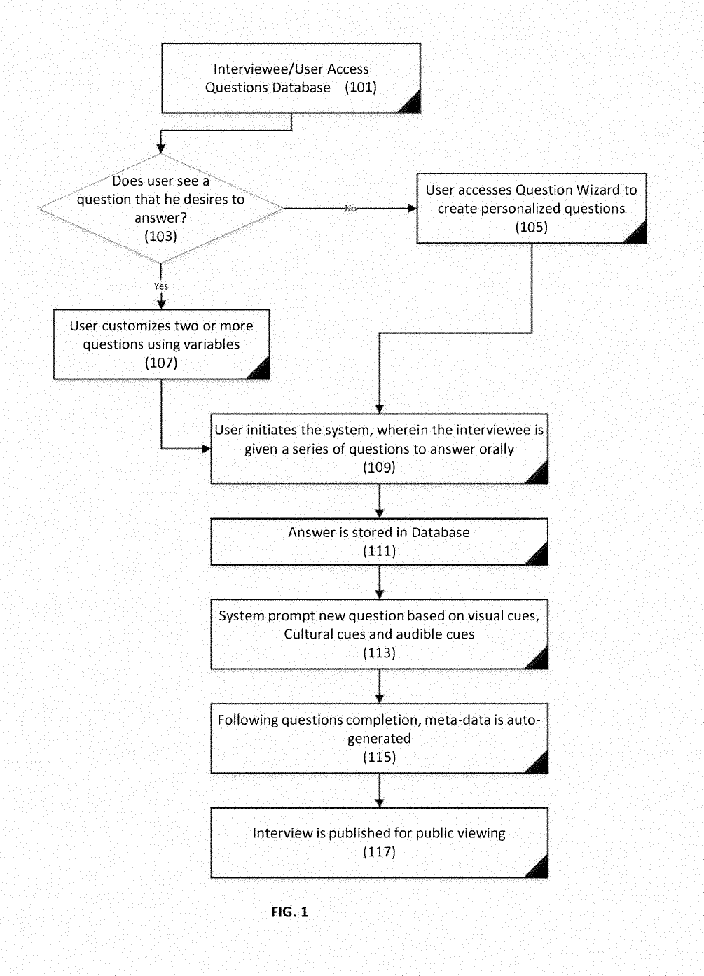

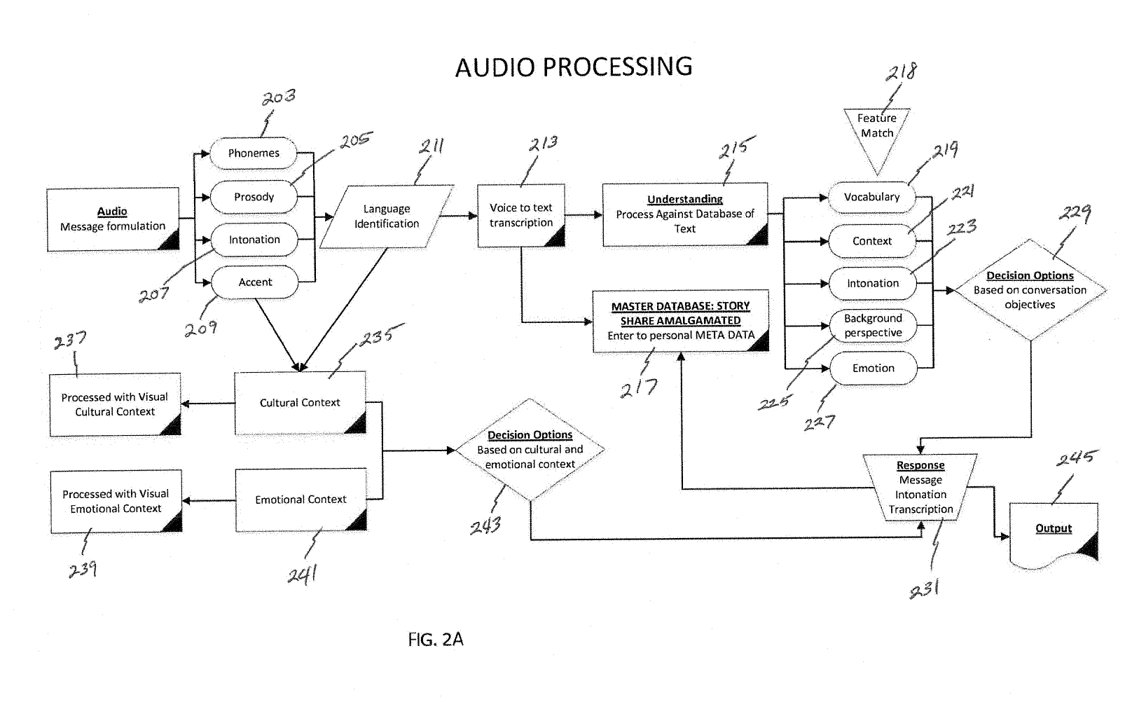

With reference to the figures, FIG. 1 is an embodiment of an example method. As shown, an interviewee (e.g., prominent figure) accesses a question database 101. The question database is generally stored at an off-site location and is accessible via a remote network. In one embodiment, the interviewee may be located in, for example, one country, but accesses the question database that is located on a server in another country. The question database has stored thereon at least one question that will be presented to the interviewee. The question, or questions, may be stored in a variety of formats and computer languages, for example .txt format. In one embodiment, questions may exist as audiovisual questions, corresponding text questions, and tags. In such an embodiment, the audiovisual questions may be stored separately from the text versions of the questions and tags. The text versions may be created by voice to text transcriptions. Upon accessing the question database, the interviewee may select which language the question(s) should be presented in. The ability to choose from various languages can be implemented by storing versions of the question(s) in multiple languages, including sign languages, in separate, relational databases that are cross-referenceable.

An interviewee may locate a specific question, inquiries, challenges, or calls-to-action using search criteria. In one embodiment, the interviewee can be asked a question directly by a non-interviewee who has access to the system. Furthermore, the interviewee may answer any question on the question database, irrespective of if he or she has received the question directly. Asking a question of any interviewee that may be using the system to conduct an interview can occur using a “Question” tool, wherein a non-interviewee can record a question using video means, audio means, text, or display means such as by a graphic user interface.

In one embodiment, search criteria used to locate content can include metadata descriptive information, wherein metadata descriptive information is information relating to characteristics of, in this case, a question, inquiry, challenge or call-to-action and/or responses. Example of metadata used to locate content from the database includes interviewees whom answered the question, subject matter of the question and responses, language the question was presented in, the person who created the question, etc. Metadata can be auto-generated through a statistical analysis of content, for example through the word cloud. In another embodiment, metadata can be created by the person who created the question and/or by the user who responds.

Upon accessing the question database, the user reviews the various questions to determine if there are questions he desires to answer 103. The interviewee may select the question(s) he desires to answer and place in a digital shopping cart-like feature. If there are no questions the interviewee desires to answer, or if the interviewee desires to create personalized questions, the interviewee may access a Question Wizard 105. The question wizard allows the interviewee to type in a question that he would like to ask, and video record a question the interviewee would like to answer or have answered. Questions created via the question wizard are entered into the Question Database and added and processed in the interviewee's meta data.

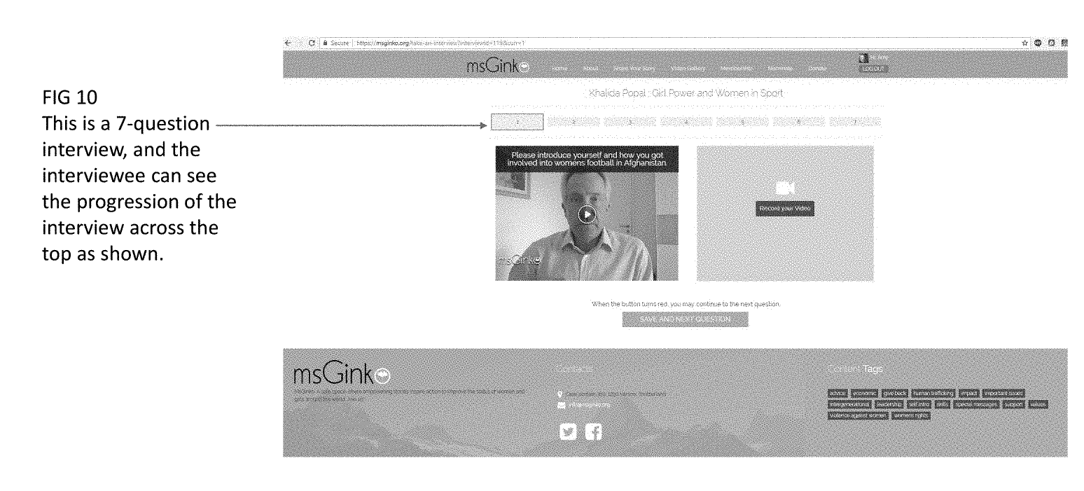

When the interviewee locates question(s) that he desires to answer, the user may customize the question using variables 107. In one embodiment, the interviewee may organize the questions in the preferred order of presentation. The interviewee then initiates the interview system 109, wherein the series of selected questions are presented to the interviewee. The questions may be presented visually on a graphic user interface (GUI), for example a computer terminal, the questions may be presented orally, for example a voice overlay “reads” the interview question to the interviewee, or the questions may be presented both orally and visually simultaneously. In one embodiment, oral presentation of the question occurs by computer synthesized speech, which “reads” the question to the interviewee. In one embodiment, an example from academia, the complete, upcoming interview questions are made available to the interviewee so that he or she may pace and understand where they are in the interview process, for example the interviewee can determine the interview is 7 questions long, and he is on question 1 (see FIG. 10).

Following the presentation of each question, the interviewee answers the questions 109. The interviewee's responses are then recorded by visual and audio recording equipment available through using their device, such as computer, mobile phone, tablet, etc. The answer and all associated metadata are automatically stored in a remote folder of a remote database associated with the interviewee 111. Each interview performed by an interviewee will be stored as a separate item, whereby the various interviews can be compared to reveal trends in the interviewee's behavior, speech patterns, overall attention, and length of submitted answers. The interviewee's data may also be compared and amalgamated across the larger body of content. Qualitative and quantitative progress can then be matched to education competencies, learning requirements, or other educational benefits.

The visual and audio recording equipment may be incorporated within the equipment the interviewee is using to conduct the interview presented to him. Each response to a question generates a visual and audio file, combined with relevant text and manually inputted tags. Prior to storing the content into the folder, the file can be analyzed 113. Analyzation may consist of “breaking down” the file into separate audio, visual, and text components. The purposes of file analyzation prior to filing is to gauge the visual cues, emotional cues, cultural cues, and audible cues particular to the interviewee. For example, if the interviewee was presented with an interview question that required an “affirmative” or “negative” response, the interviewee's “body language” will be analyzed visually and compared with other visual responses by other interviewees. The system will then modify future questions based on the “cultural cue.” Culture includes differences between national cultures, or regional differences within a larger culture, for example different regions of various countries.

As the interview questions continue to be provided, answered, and the answers analyzed by visual cues, the interview questions continue to be made more automatically tailored and specific 113. Near or at the beginning of the interview, the interviewee should feel as though he or she is speaking with a person from his own culture. In a preferred embodiment, modification of the interview questions occurs based on visual cues, audible cues, emotional, and other cultural cues. It is believed that interviewees will provide more detailed, introspective interviews as their level of comfort increases because they believe they are speaking with someone who “understands them and their culture.”

Following completion of the interview, meta-data is then either entered into the system manually by the user or auto-generated 115. Meta-data can refer to—but is not limited to—any aspect of the interview that characterizes the interview, for example the name of the interviewee, the language the interview was performed in, subjects covered in the interview date of the interview, etc. In one embodiment, the meta-data is auto-generated by the various cue analysis meta-data, for example word cloud generation. Meta-data can be either public, meaning it can be used by others or specifically identified groups of users to categorize an interview, or private, meaning only certain people have access to this information. Examples of private meta-data includes storing key elements, chosen by the interviewee, on servers in locations of their choice, for example the USA, Ireland, or Switzerland. Private meta-data may be stored in a separate location from their content. The interview is then made available to the public on a remote server 117. Access to the interview can be via website access and the like.

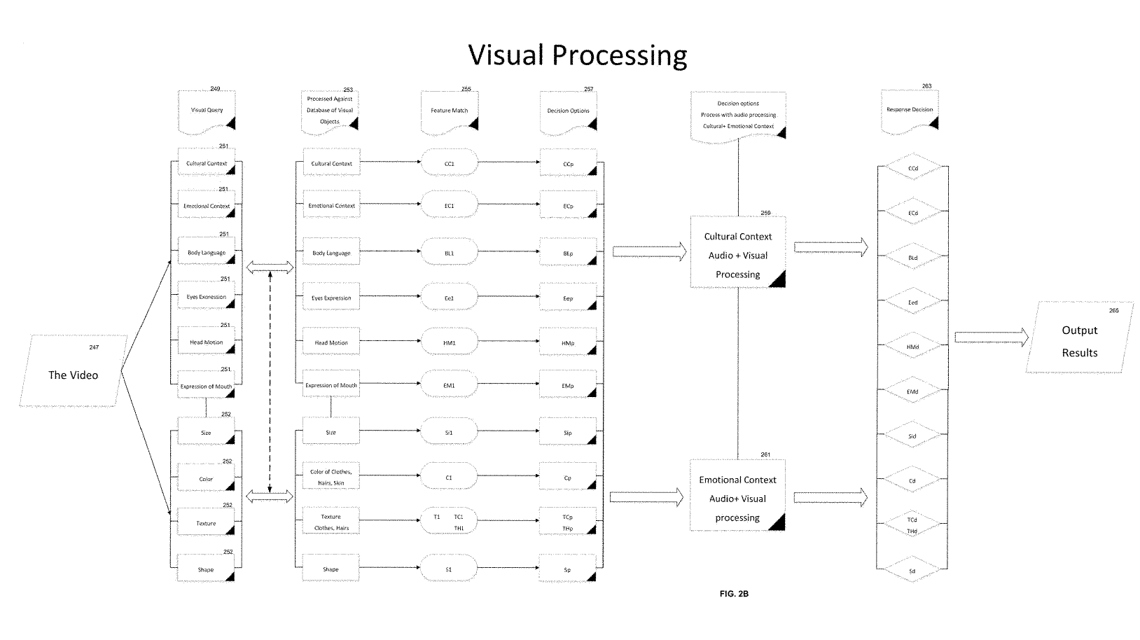

FIG. 2A is an embodiment of an aspect of the example embodiments disclosed herein, whereby the audio component of an interview can be analyzed to provide feedback, which in turn can be used to modify the interview questions to better suit an interviewees culture and emotional state. The feedback is obtained by determining various cues specific to each interviewee. During an interview, audio information 201 is collected. In one embodiment, the audio information is collected following each answer to an interview question. The audio information may be collected by a microphone using the interviewee's device to perform the interview. In another embodiment, the audio information may be collected using a standalone microphone. Audio pickup, or collection of the audio signal, can be obtained using instrumentation suitable for the human voice. Instrumentation suitable for the present system allows categorization of the audio signal, to result in pattern recognition. It is known that human speech occupies an audio spectrum of between about 30 Hz to 3 kHz. In a preferred embodiment, an example system includes a digital server processor (DSP) to focus the frequency of the microphone within the human voice range.

The example system allows a determination of the audio pattern recognition of the interviewee. Areas of pattern recognition includes determining the phonemic 203, prosodic 205, intonation 207, and accent 209 characteristics. In one embodiment, in determining the phonemic characteristic, the example system is suitable for determining speech sounds of the interviewee. In another embodiment, in determining prosodic characteristics, the tune and rhythm of speech including the pitch, loudness, and rhythm of the interviewee utilized during the interview.

In yet another embodiment, in determining intonation, the pitch of the interviewee is recorded and measured, which may provide insight into the personality and mood of the user. In still yet another embodiment, the accent of the interviewee is recorded and measured and integrated into the cultural meta-data master file for the specific interviewee.

Following categorization to gauge pattern recognition, the language of the interviewee can be identified 211. Identification can occur through a comparison means, whereby the categorized areas of pattern recognition for the interview are compared to previously stored information relating to a human language. The stored information relating to human language forms a baseline. In another embodiment, the interviewee, through the system, can select his or her mother tongue or preferred language.

Data from the categorized pattern recognition and determination of the language identification are forwarded to determination cue information including cultural context 235 and emotional context 241. Both the cultural context 235 and emotional context 241 are processed with the visual data, whereby the visual data is obtained via the video recorded during the interview. Processing with the visual data results in a cultural context cue 237 and an emotional context cue 239. The audible data is then used to produce a text transcript 213, wherein it is processed against an existing language database of text 215. The selected language database of text is selected from the identified language of the interviewee 211. The transcribed text 213 may also be used to generate metadata 217. As previously mentioned, the metadata is utilized for organizing the interview into categories which allows content to be searched and personalize the experience for the user accordingly. The various aspects of the interview, including vocabulary 219, context of the use of words 221, intonation employed by the interviewee in the interview 223, background perspective 225, and emotion exhibited during the interview 227 enable analysis and personalization of the experience of and for the user. The results 229 of the feature matching 218, when combined with the results 243 from the emotional cues and cultural cues can be combined 231 to deliver a feedback output 245. The feedback output 245 can be employed to modify future interview questions.

FIG. 2B is an embodiment of the visual processing of the interview to result in feedback that will be useful in modifying future interview questions presented to the interviewee. Following the answering of an interview question 247, which produces video data, the video data is analyzed for a variety of aspects relating to the performance of the interviewee in answering the question 249, including 251, for example, cultural context, emotional context, body language, eye movement/eye expression, body movement including head movement and upper body movement, mouth expression, and the like. The video data is also analyzed for body size, skin appearance, environmental cues, racial appearance, sexual references and orientation, hair texture, and body shape. The video data can also be analyzed for a variety of aspects relating to other visual aspects 252, including backgrounds/backdrops (e.g., indoors, outdoors), color and style of clothing, and any other visual clues that can be gleaned from the settings of the interviewer or interviewee. The user may choose to make visible time and date stamps, as well as location mapping. The analyses result in data fragments with corresponding tags, wherein each fragment corresponds to the various visual characteristics derived from the video data. The data fragments are then amalgamated and compared against benchmark data fragments 253. The benchmarks data fragments are created from previous analysis of other third-party interviews that have been complied and analyzed as compared to external cultural, emotional and body language research to form “big data” sets. Features are matched 255 from the benchmark to the interviewee's actual video data and a determination is made as to the cultural aspects of the interviewee 257. The decision 257 will then be assimilated with the conclusions concerning the audio processing related to the cultural context 259 and emotional context 261 of the content. The matching results in the selection of specific interview questions 263, and eventually provides a feedback 265 for further tailoring of the interview to the interviewee.

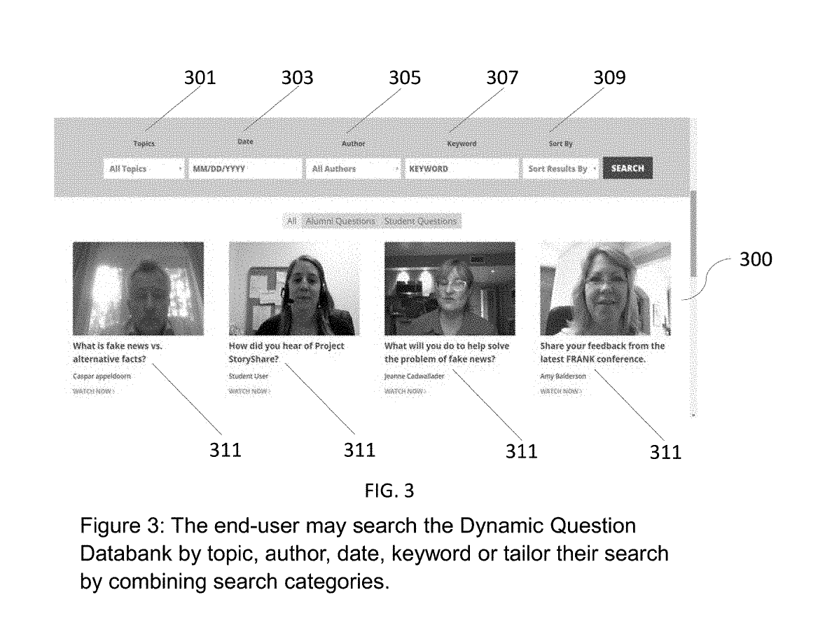

FIG. 3 is an example embodiment wherein an interviewee can use the present system 300 to select at least one interview question from the question database. As shown, the interviewee may select from at least one variable (301, 303, 305, 307, 309) for narrowing the various interview questions stored within the question database. All content (writing of questions, manually inputted tags, topics, dates, author, as well as conclusions from visual and audio processing) is searchable metadata 307. In another embodiment, a search bar positioned across the top may allow a user to locate their desired interview questions across the entire site. The selection of variables leads to the presentation of interview questions 311 to the interviewee. The interviewee can select variables including theme, category, location, topic, demographic, etc.

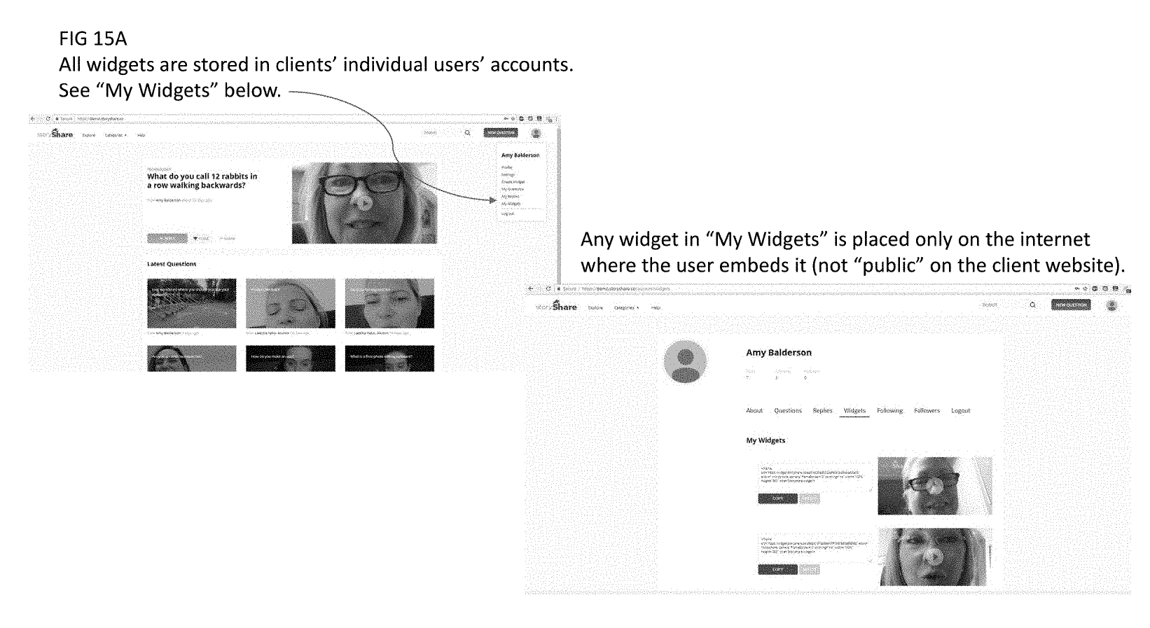

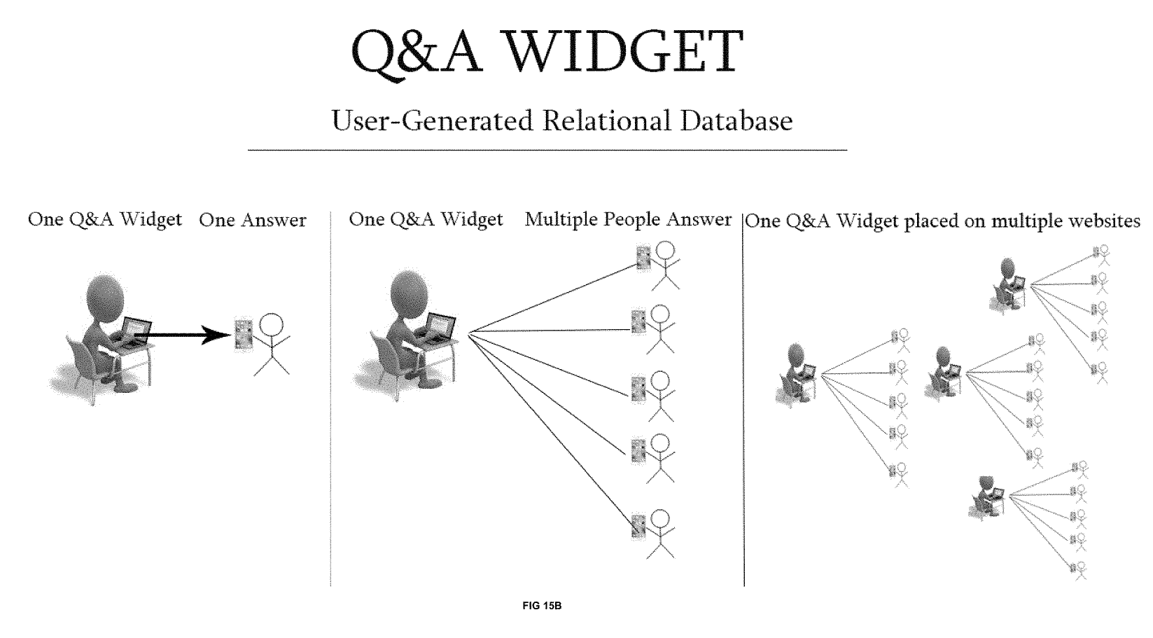

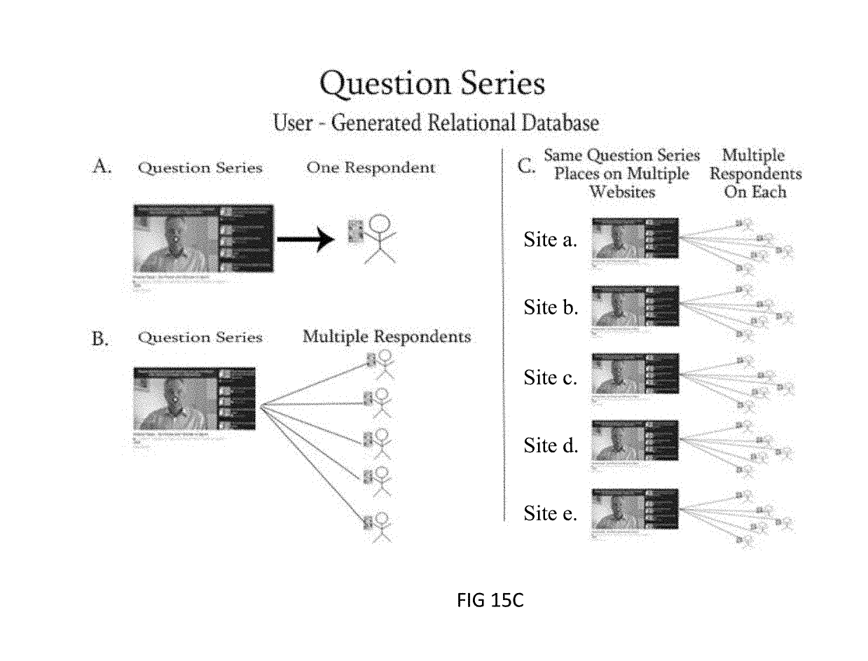

The interviewee, within the interface, may also choose which questions to answer, (thereby creating their own interviews), the order of questions and corresponding answers, make certain questions and answers private, or make certain questions and answers only available to specific groups within their online community. A user may also create a tailored interview and submit this new interview to another user to answer (see e.g., FIG. 15B and 15C).

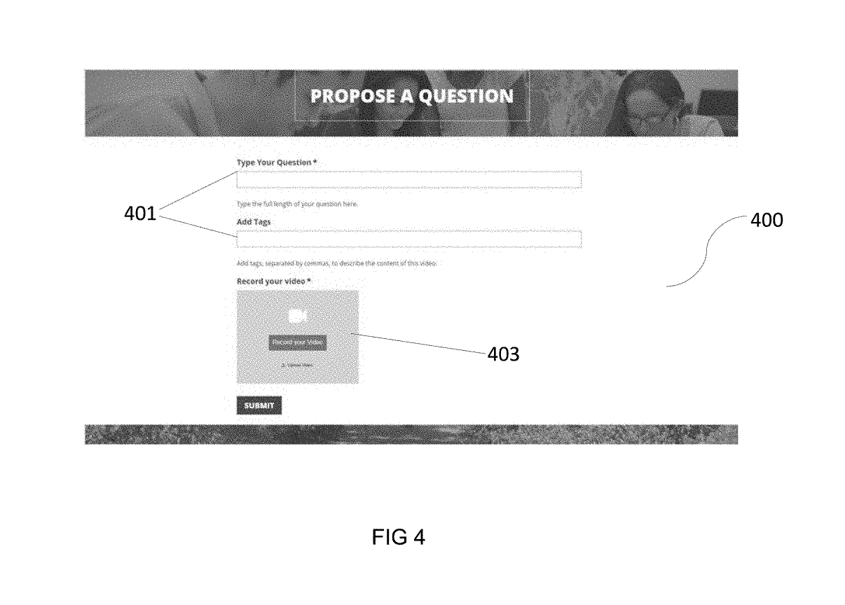

As shown in FIG. 4, in the event the interviewee desires to create one or more personalized interview question via the question wizard 400. The user manually writes the question and related tags associated with the content 401. The user may either record directly from the interface or upload an existing video 403. The user may re-record as many times as they wish until they are satisfied with their recording. Once the user presses “submit” the content is entered into the master database.

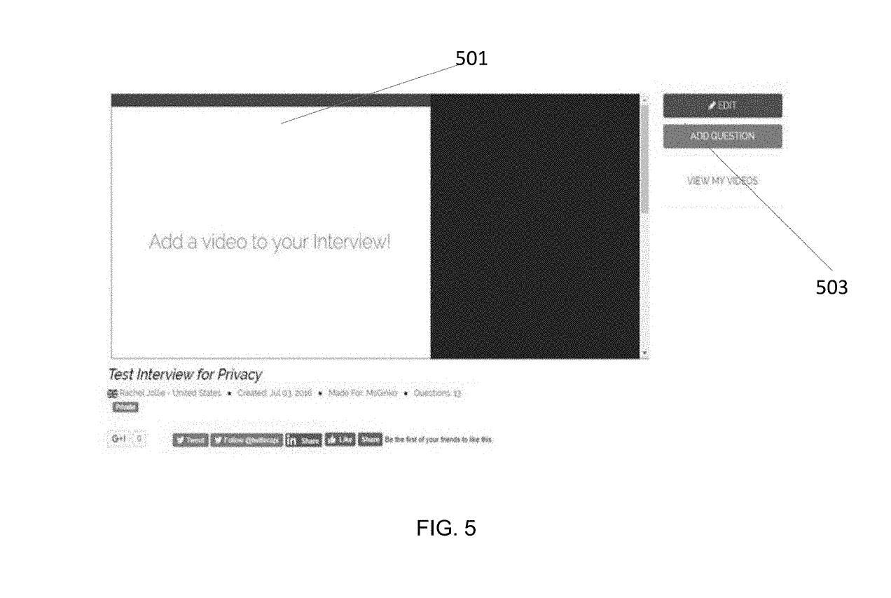

FIG. 5 illustrates an example embodiment wherein the interviewee can create interview questions and multiple-question interviews, including a viewing area 501 and controls 503. As stated, recording interviews can include recording both visual and audible questions while inputting relevant text. The recording of the visual and audible questions allows the system to determine visual, audible emotional and cultural cues. Such case analysis provides a feedback mechanism that allows better culturalization of future interview questions. Such culturalization of the interview questions allows the interviewee to feel more comfortable and likely to provide more in-depth, personal responses during the interview. Once the interview is created, the user is capable of sharing it on social media to promote engagement.

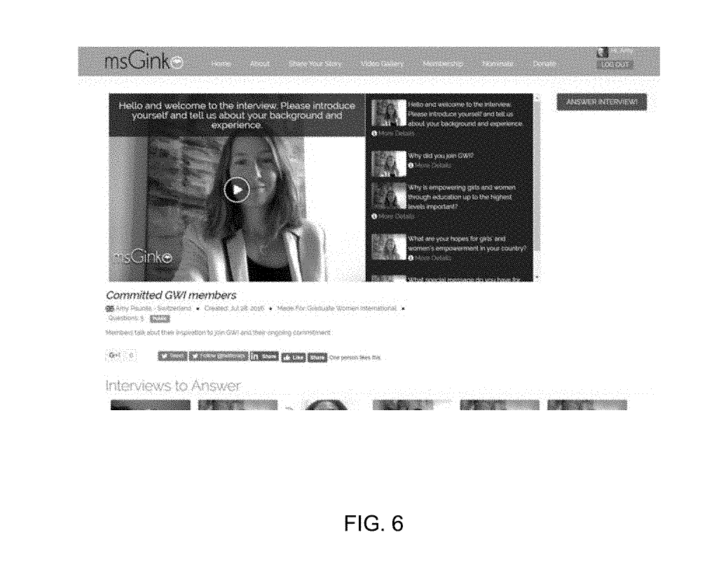

FIG. 6 is an example embodiment wherein the interviewee can preview interviews in sequence before answering them, for example, presented as a playlist. The interviewee can have full control of creating their content and related information. The interviewee can add documents, audio recordings, photographs, various media, specific asynchronous audio-visual questions and answers, topics, complete or parts of interviews, delete, re-record, change the order of questions, edit, and replace any content with new content. The user may share the interview with one or more users, specific groups and control the timing of the release or request for responses. Further, with users' permission, any user may embed any interview on any website across the interne.

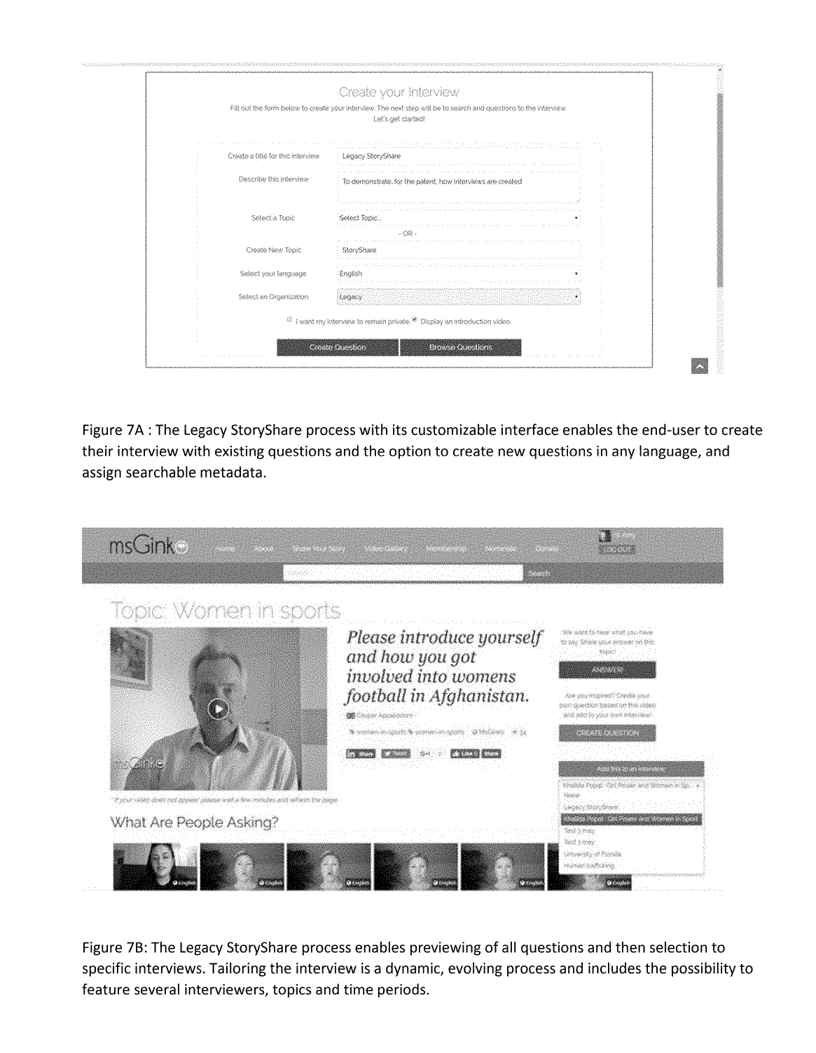

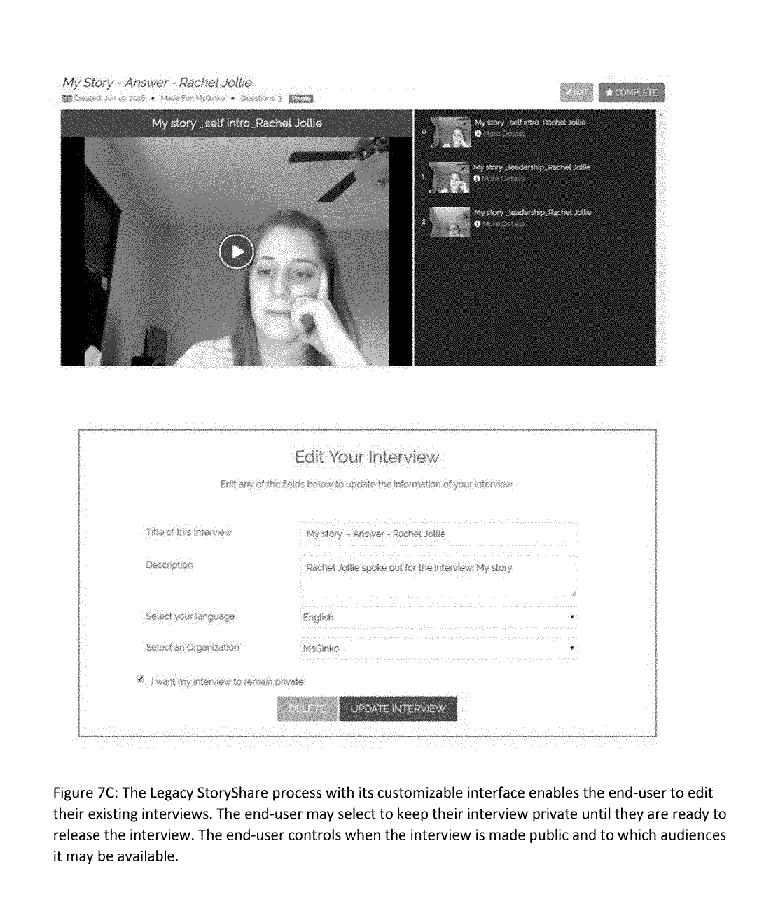

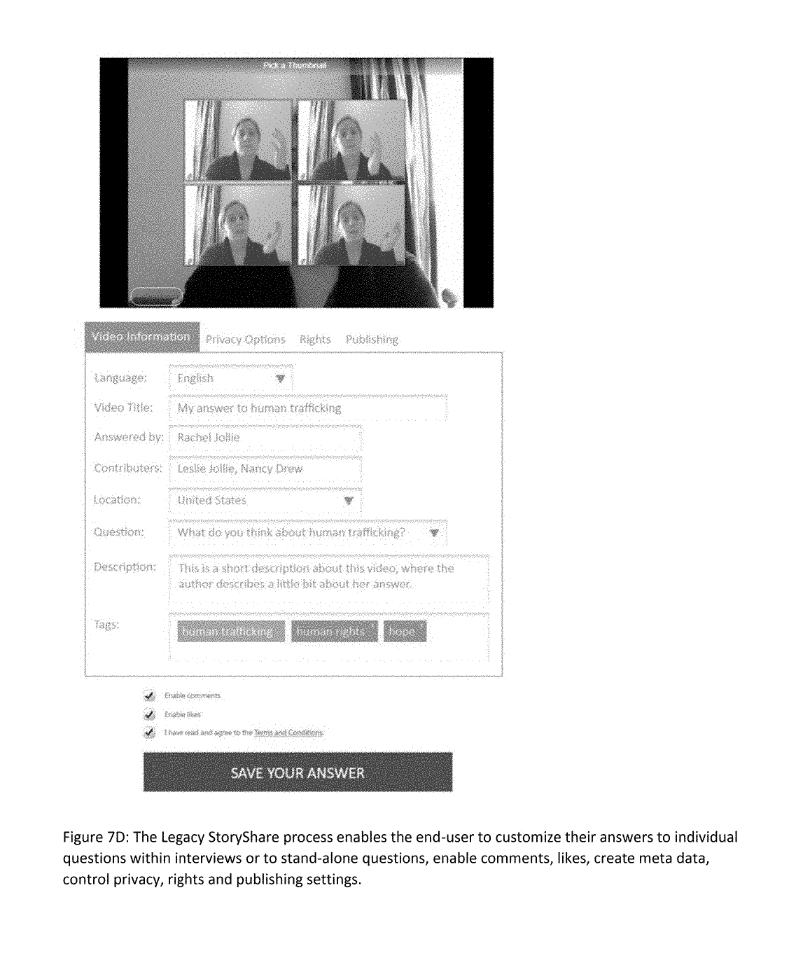

FIGS. 7A-D illustrate embodiments wherein users may create audiovisual interviews. Questions may be recorded with corresponding user-generated or automatically-created meta-data. Interviews may be edited, and the sequence of the questions changed. With each change, the previous metadata is stored, where it may be compared with the updated version of the interview and responses. In one embodiment, interview questions from a third party are presented to an interviewee on a graphic user interface via visually (in writing) and orally. On the graphic user interface, the interviewee can select additional questions to answer during the interview. Further users may manage their replies to questions and enable comments, likes, creation of further metadata, control privacy, rights and publishing settings 7D.

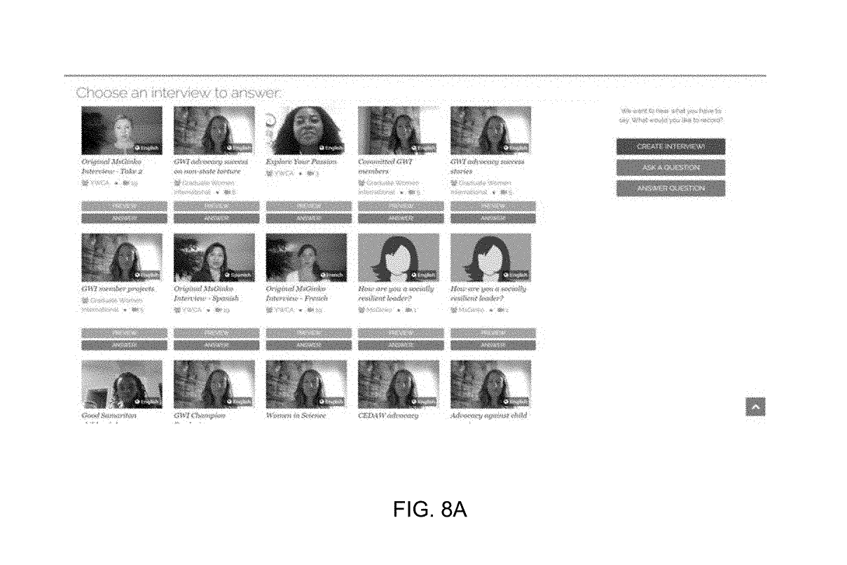

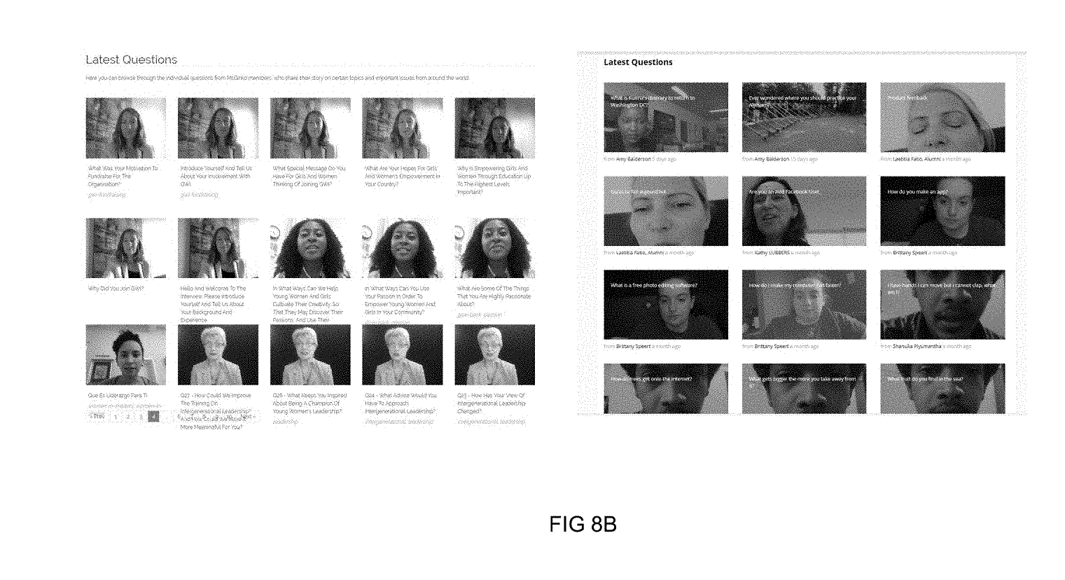

FIG. 8A is a visual representation of the interview database, whereby an interviewee may select one or several existing interviews to answer. FIG. 8B is a visual representation of the questions database, whereby an interviewee may select one or several existing questions to answer.

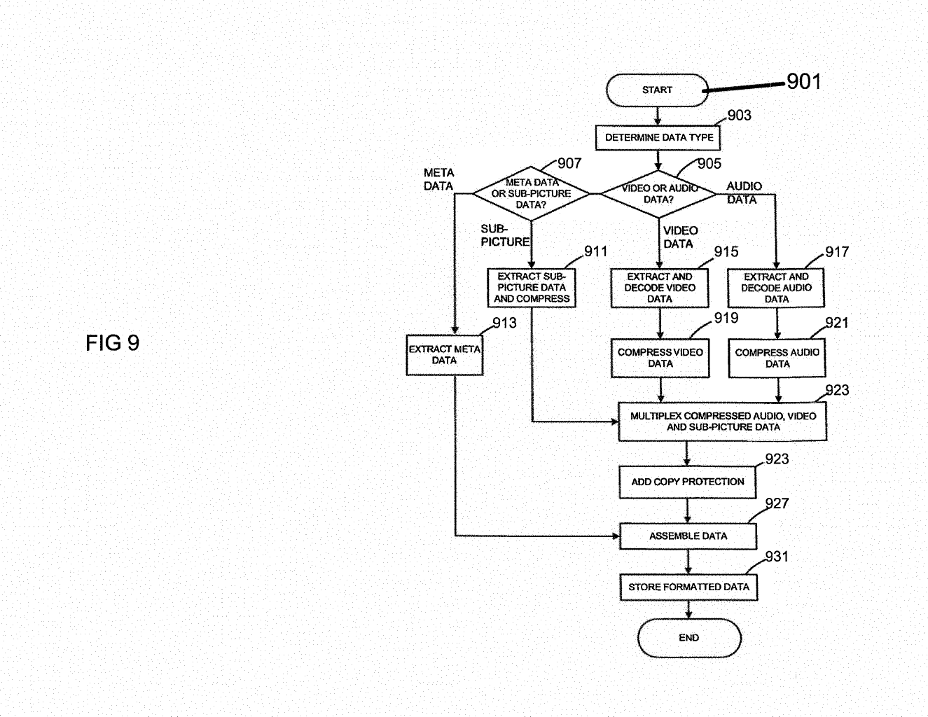

FIG. 9 is an alternative embodiment, wherein upon completion of an interview question, the interviewee's answer is forwarded to determine in what medium the answer should be analyzed 903, in this case either video (visual) and/or audio 905. In the event the system will analyze the response via audio data, the audio data per se will be extracted from the interview and decoded 917. To allow for easier storage of the audio data, it will be compressed 921.

In the event the system will analyze the response via video data, the video data per se will be extracted from the interview and decoded 915. To allow for easier storage of the video data, it will be compressed 919. Metadata, which includes text and sub-picture data, will be obtained from the overall data 907, resulting in extracted sub-picture data 911 and extract text metadata 913. Both compressed video data and audio data, and the sub-picture data will be multiplexed compressed and combined 923. Copyright and digital rights information will be entered into the combined data formats 925, and the text metadata will be added thereto 927. The eventual formatted data will be stored on a remote server for access and can be retrieved by third parties according to the users' instructions 931.

FIG. 10 is a visual representation of how an interviewee moves through and can pace him- or herself during an interview. As the user answers each question, the sequencing of the questions and location in the process is visualized against the total number of questions.

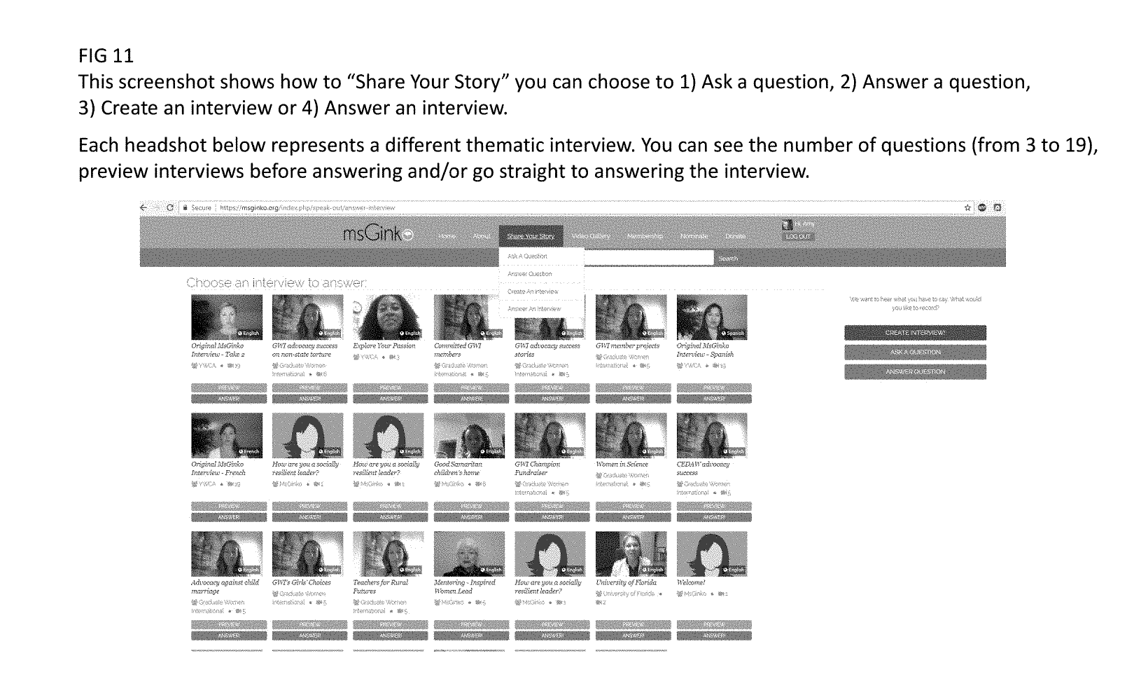

FIG. 11 is an example embodiment wherein the interviewee may choose from a variety of existing thematic interviews to answer. In the embodiment of FIG. 11, a user may choose to share their story by selecting between (1) ask a question, (2) answer a question, (3) create an interview, or (4) answer an interview.

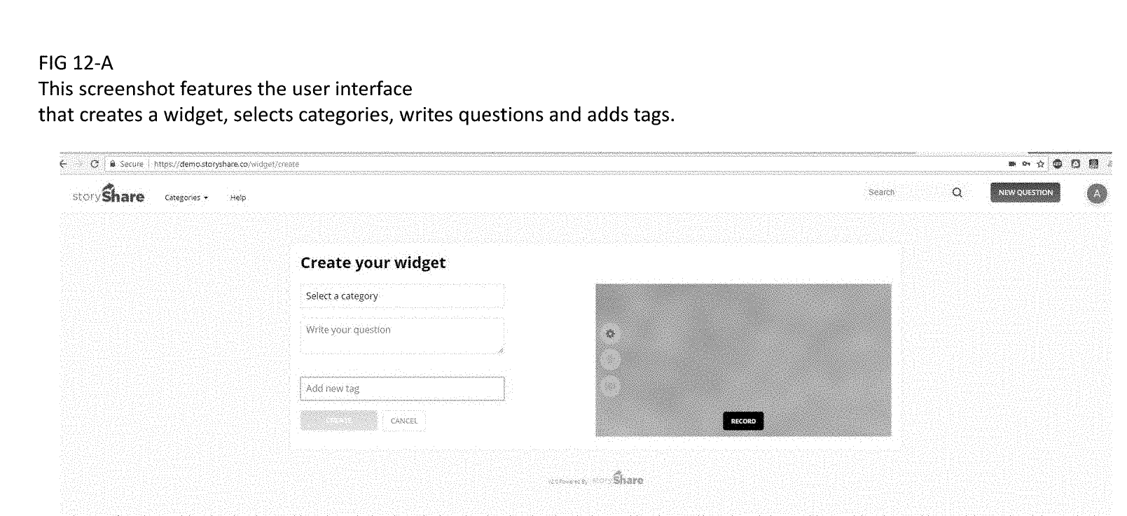

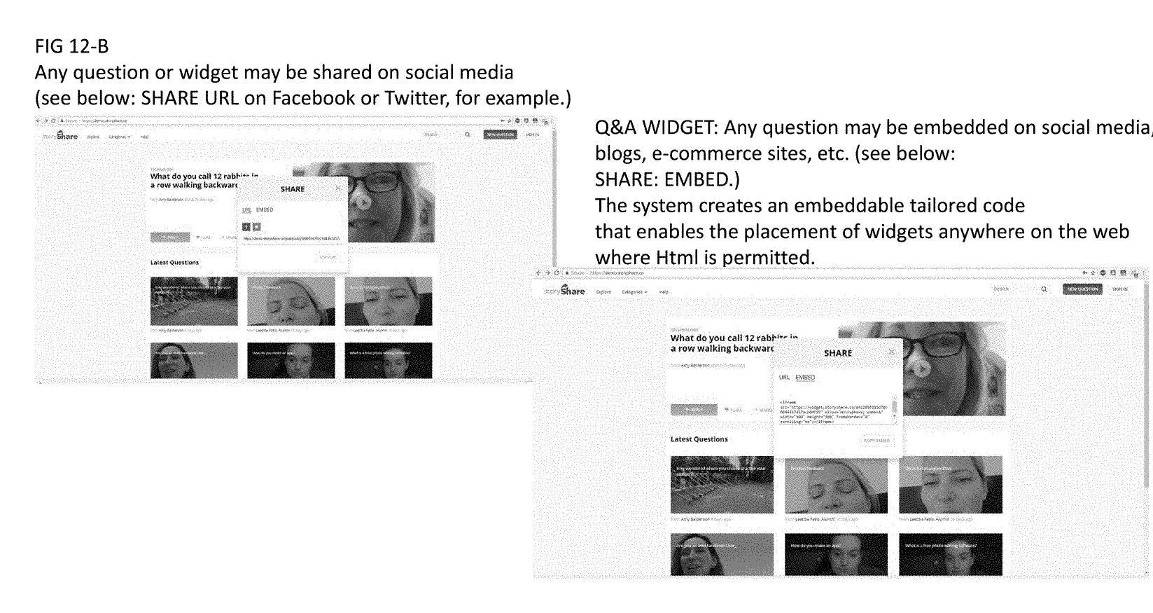

FIG. 12A illustrates a Q & A “widget creator.” The widget creator records audiovisual questions, and enables the user to select categories, write the question and include tags, all of which become searchable metadata. FIG. 12B illustrates generating unique embed codes for each widget or question, enabling following of questions and answers wherever they are embedded across a global network, forming a user-generated virtual, audiovisual relational database. When users answer an embedded widget, the reply updates on the widget as well as on the main site, and simultaneously across the internet wherever that widget has been embedded. The user may determine whether his or her widget is visible on the main URL.

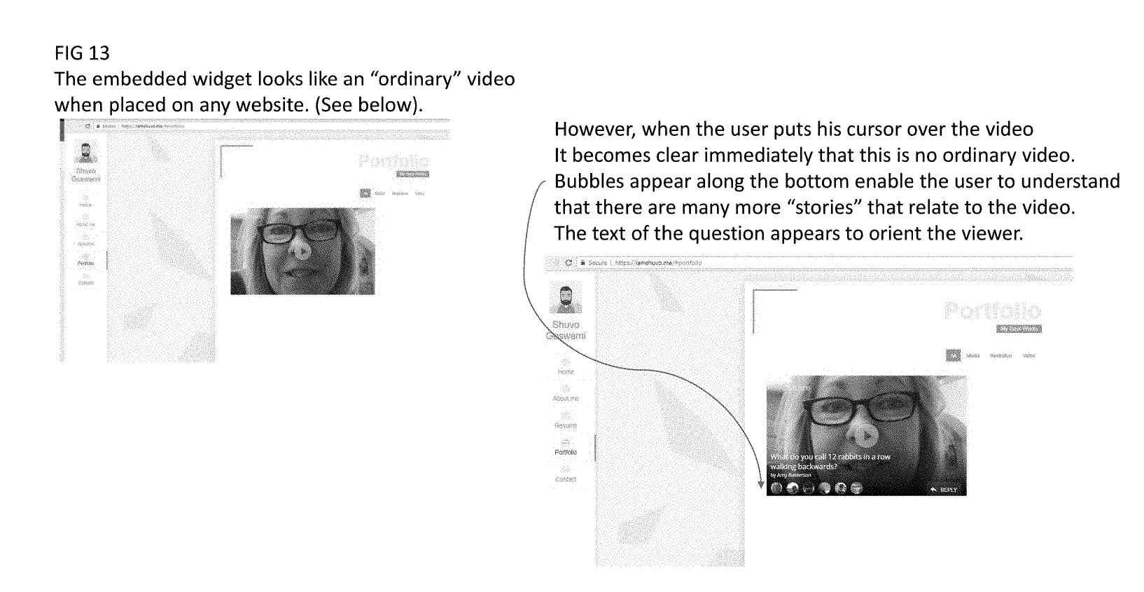

FIG. 13 shows an example embodiment embedded on an external website. The Q&A widget appears as an ordinary video. However, when the user moves his or her cursor over the image of the video to press “play,” bubbles appear along the bottom of the video screen, indicating that the video is interactive, with more content or “stories” in addition to the initially-featured video. The “reply” button also appears to indicate to the viewer user that he or she may respond and become an interviewee. A discrete flag may also appear, enabling viewers to report inappropriate content.

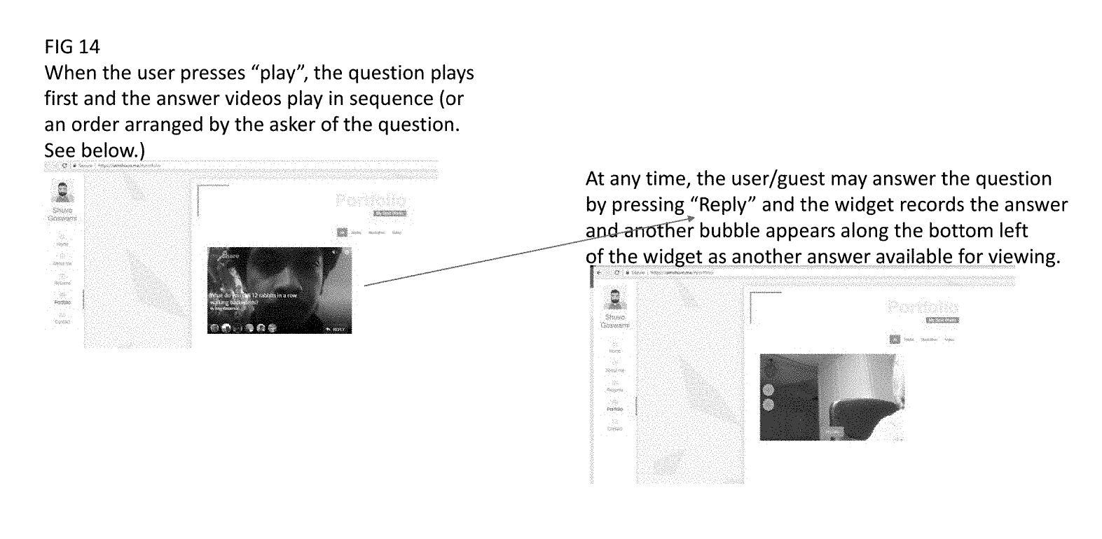

FIG. 14 illustrates an example form of a widget's behavior. When the user presses “play,” the embedded widget first plays the question and then each answer plays in chronological (or reverse-chronological) order (according to the user's instruction). Then, when the user presses “reply” he or she may respond to the question him or herself. This process may take place anywhere on the web where the widget is embedded. The widget may appear as created by a single-user on one website, or as part of a white-labeled platform solution.

FIG. 15A illustrates individual user accounts including questions and widgets in separate locations. Questions can appear publicly on the client site, and widgets may be created from questions, and placed anywhere on the web. In this case, when users reply to the embedded widgets, the questions on the client site as well as the embedded widgets update instantly. Payable widgets are not public, and may be created separately from the client site, and embedded anywhere on the web. The user can manage the widget through their personal dashboard. FIG. 15B illustrates an example form of widgets as a user-controlled means of creating audiovisual relational databases by managing his or her widget placement. Payable widgets do not necessarily appear on client websites; rather, they may be placed in situations on the web whereby an individual respondent may answer (one-on-one embodiment), one on many embodiment (placing one widget on one site for a specific audience comprised of one or more potential users) or many on many embodiments by placing the same widgets many places on the web. 15C illustrates an example form of automated interview as a user-controlled means of creating audiovisual relational databases by managing his or her interview placement. Interviews may appear on client websites or be placed in situations on the web whereby an individual respondent may answer (one-on-one embodiment), one on many embodiment (placing the interview on one site for a specific audience comprised of one or more potential users), or many on many embodiments by placing the same interviews simultaneously across many URLs on the web.

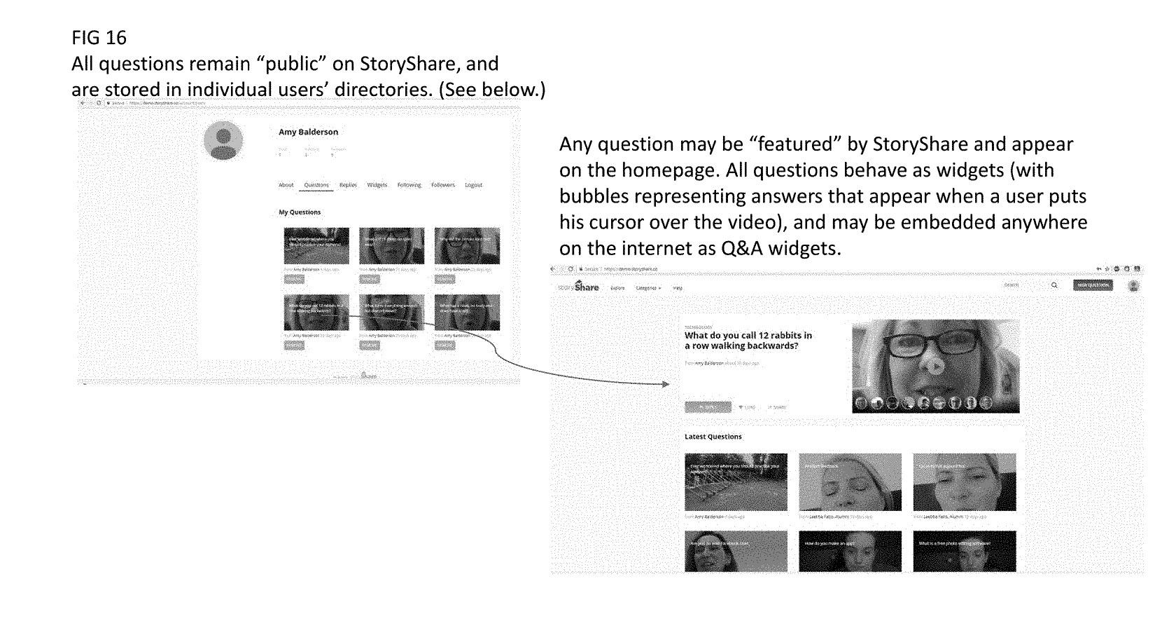

FIG. 16 illustrates an example client site whereby questions may be created for treatment (replies, sharing) in a public or private environment. Any approved user of the system “social media” may ask or answer any question in the environment. Any question may be shared as a Q&A widget.

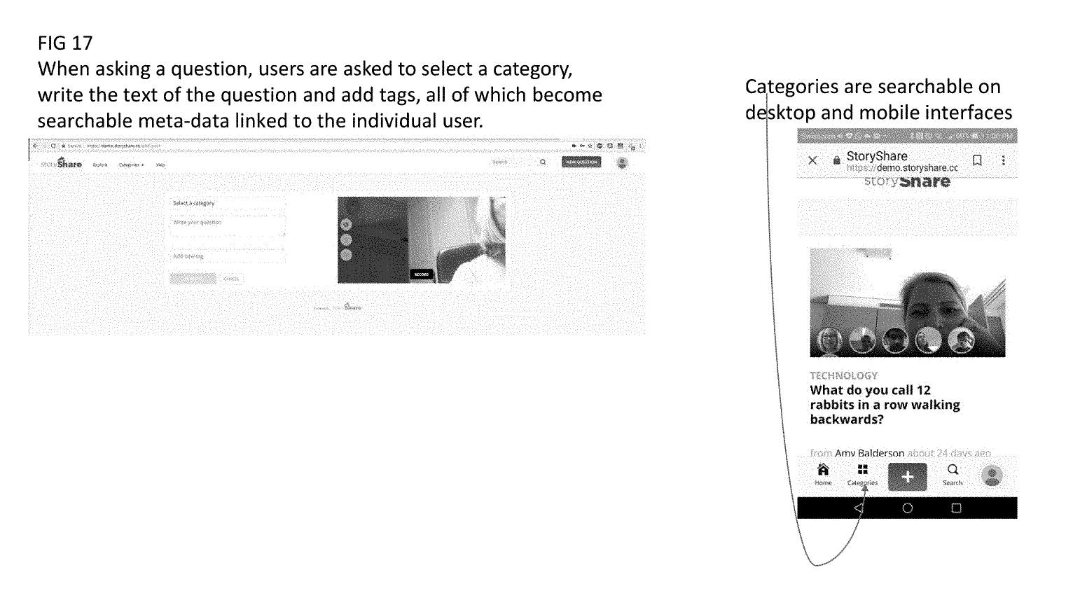

FIG. 17 illustrates example embodiments across various browsers and devices.

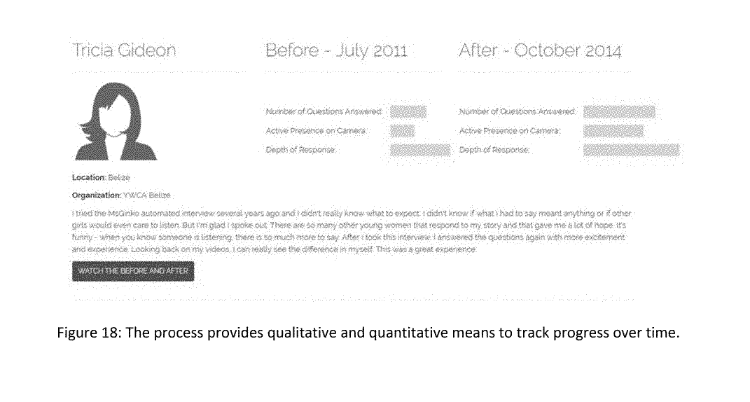

FIG. 18 illustrates an example embodiment that presents comparisons of a user's behavior and performance over time. The system enables responses to the same questions to be compared following training or other intervention to demonstrate qualitative differences in a user's behavior, speech patterns, overall attention, and length of submitted answers, etc. Statistics may be gathered from these comparisons and displayed as visual graphs to track progress in a certain theme over time. Progress can then be matched to educational competencies, learning requirements, or other benefits.

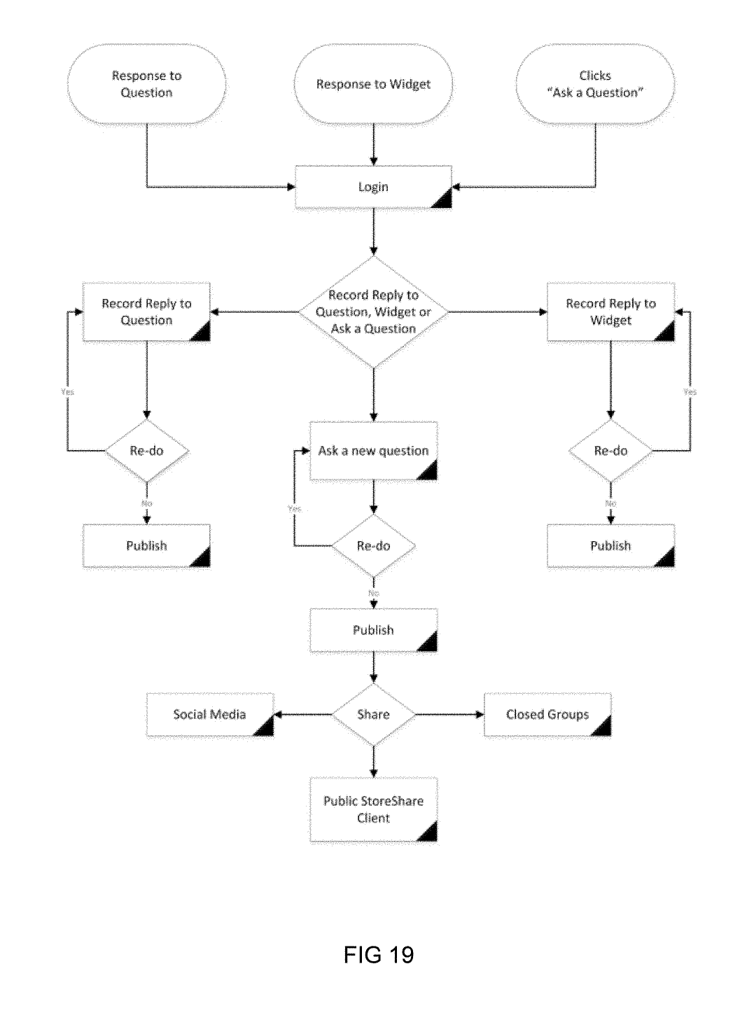

FIG. 19 illustrates an example embodiment of how a user logs-in to an example platform: either by responding to a question or a widget, or by asking a question. A user is not necessarily obliged to sign-in to view content, according to the distribution control indicator of the client user.

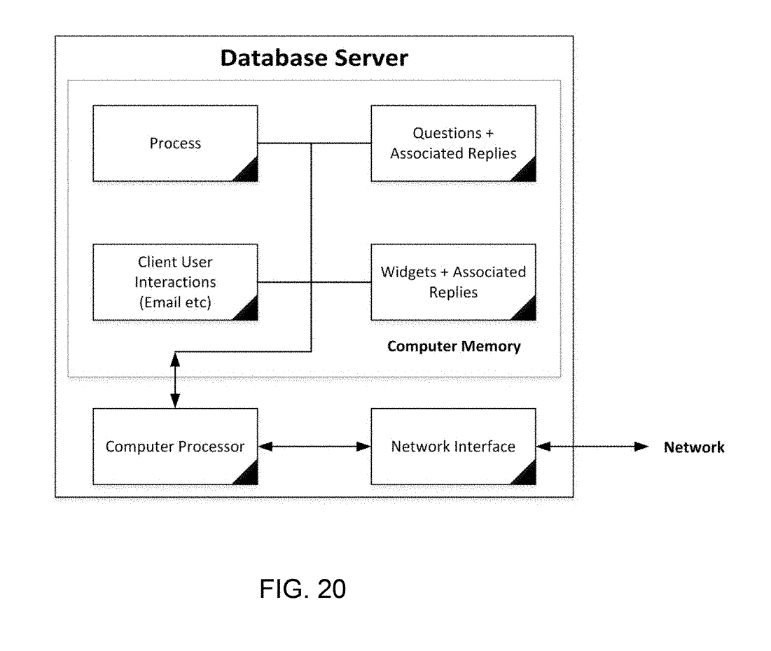

FIG. 20 illustrates an example embodiment of an underlying processes and other aspects of a software system stored in memory. All aspects of content creation, comparison, and interaction can be amalgamated in the master database.

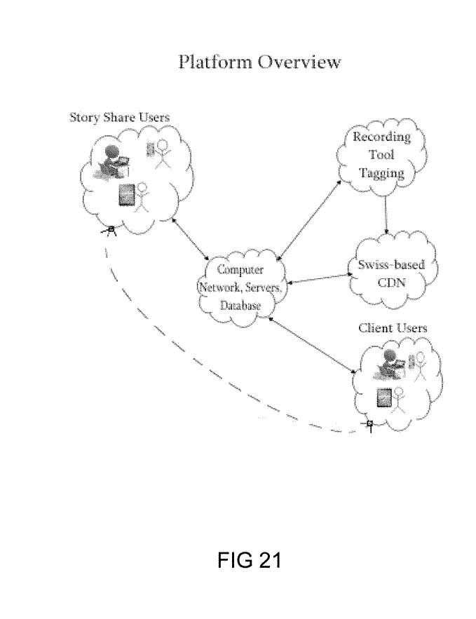

FIG. 21 illustrates an example embodiment of how users can interact with the master database. Each client has its own database, and the master database with amalgamated data strengthens the quality of overall content.

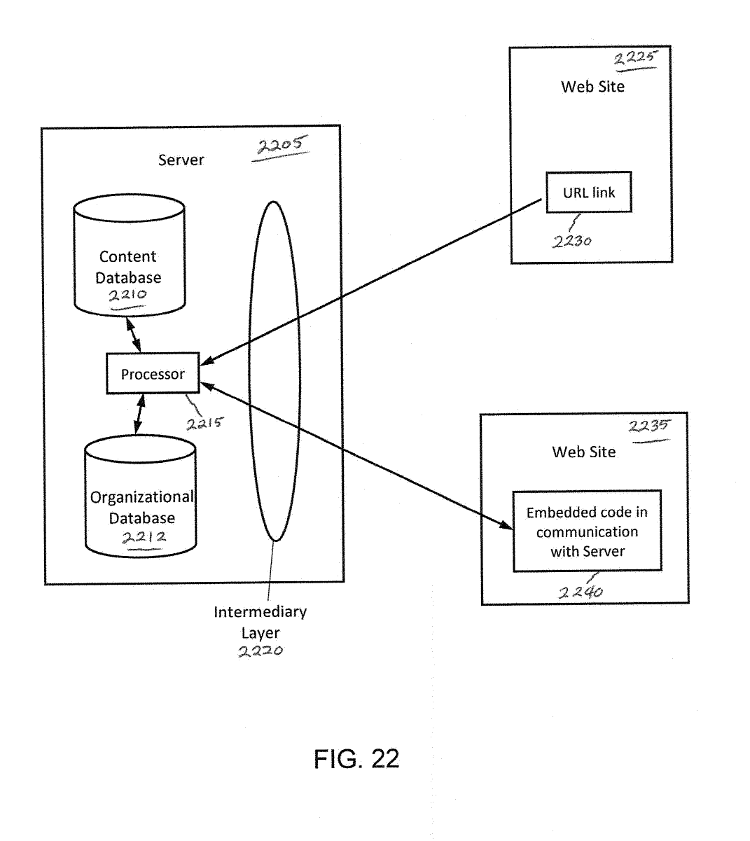

FIG. 22 is a block diagram illustrating a system for providing interactive collaboration over a computer network, according to an example embodiment. The example system includes a content database 2210, an organizational database 2212, an interface (e.g., 2230 and 2240 via 2220), and a processor 2215. The content database 2210 is configured to store digital content created by at least one user. The interface 2230, 2240 is configured to provide access to the digital content by other users and to enable the other users to provide feedback related to the digital content in a similar format as the digital content. The processor 2215 is in communication with the databases 2210, 2212 and the interface 2230, 2240 and configured to implement an intermediary layer (e.g., application programming interface (API)) 2220 between the databases 2210, 2212 and the interface 2230, 2240. The intermediary layer 2220 is configured to control which users can access the digital content, to store the feedback from the other users in the databases 2210, 2212 in a manner that is associated with the digital content, and to provide users with controlled access to the feedback. The digital content and feedback can be in video or other media format, and a user accessing the video content can be enabled to provide feedback. By way of example, the intermediary layer 2220 can be implemented using Ruby on Rails.

The example system illustrated in FIG. 22 includes a server 2205 hosting a content database 2210 and an organizational database 2212. One example interface is shown as a URL link 2230 on web site 2225. Another example interface 2240 is shown as embedded code 2240 on web site 2235. In the example embodiment, both web sites 2230 and 2240 are shown as being remote from the databases 2210, 2212. Also in the example embodiment, both databases 2210, 2212 are shown as being hosted on a server 2205. In other embodiments, however, either one of the databases 2210, 2212 can be at a different location. For example, the content database 2210 may be at a remote location, or the organization database may be at the location of the interface. In an example embodiment, there may be multiple organizational databases, co-located with a plurality of interfaces. The databases 2210, 2212 can be, but are not limited to, relational databases. Feedback to the digital content can be stored in the content database 2210, and representations of relationships can be stored in the organizational database 2212 in a manner associated with the digital content in a parent-child relationship. In such an embodiment, the processor 2215 can be configured to, when providing the digital content to the interface 2230, 2240, access the databases 2210, 2212 to determine additional digital content that is feedback to the digital content and to provide to the interface 2230, 2240 the feedback along with the digital content. The interfaces 2230, 2240 can be configured to present the digital content to a user along with one or more indications of the feedback. The interfaces 2230, 2240 can be configured to display, in one screen view, video playback of the video content and a plurality of indicators of related videos that have been provided by other users as feedback to the video content. In such an embodiment, the interfaces 2230, 2240 can be configured to display video playback of a related video in response to user selection of a corresponding indicator. The interfaces 2230, 2240 can be configured to cause the intermediary layer 2220 to authenticate a user and to accept new video content from the user as feedback to the video content in response to selection of a reply indicator by the user.

In operation, the interface 2230, 2240 can make a call to the intermediary layer (API) 2220. The intermediary layer 2220 accesses the databases 2210, 2212 and sends the requested data back to the interface 2230, 2240. When providing the interface 2230, 2240 with the requested content, the processor 2215, via the intermediary interface 2220, can provide all other content stored in the content database 2210 that is associated with the requested content, in accordance with the relationships represented in the organizational database 2212. The content may be stored in the databases along with unique identifiers, and relationships between the content can be designated by referring to the unique identifiers (e.g., by designating a parent-child relationship using the unique identifiers). When presenting video content, the interfaces 2230, 2240 can display the content using, for example iFrame, and can present the primary video content in a majority of the display, and can present smaller representations of the related video content, for example, along the bottom of the display. If the same widget is featured on both 2230 and 2240 and a response is recorded on either 2230 or 2240, the intermediary layer 2220 updates interfaces 2230 and 2240 simultaneously.

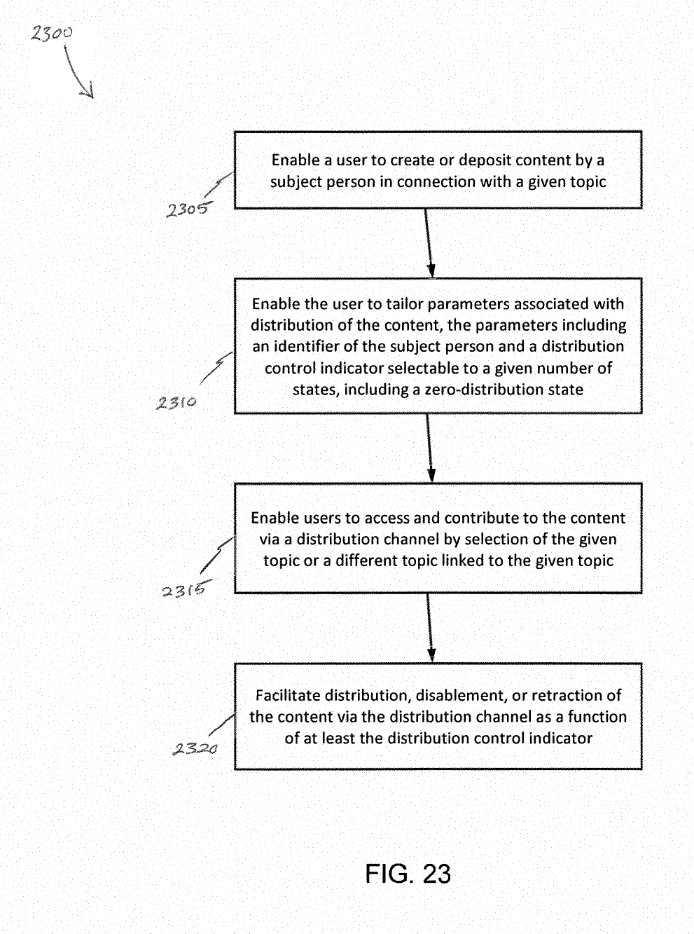

FIG. 23 is a flow diagram illustrating a method 2305 of sourcing content, according to an example embodiment. The example method includes enabling 2305 a user to create and/or deposit content by a subject person in connection with a given topic, and enabling 2310 the user to tailor parameters associated with distribution of the content. The parameters include at least an identifier of the subject person in the content and a distribution control indicator selectable to a given number of states, including a zero-distribution state. The method further includes enabling 2315 one or more other users to access and contribute to the content via a distribution channel by selection of the given topic or a different topic linked to the given topic, and facilitating 2320 distribution, disablement, or retraction of the content via the distribution channel as a function of at least the distribution control indicator.

### EXAMPLES

The embodiments disclosed herein have many uses in industry.

In the field of journalism, the embodiments disclosed herein allow a user, such as a newsroom, to design and record a video question from the newsroom or directly from the scene of breaking news scene. Embodiments can establish a channel based on the content producer's website: the content producer may launch the opportunity to respond, spread it on the web. The user will then be able to manage the incoming videos to create a compendium of content based on the interviews. The embodiments disclosed herein can create a direct channel between the newsroom or brand owner with their audience, so that fans, followers and viewers can contribute with direct and immediate recordings or uploads of their content.

In the field of university alumni associations, an association can reach out to alumni on topics they care about, any time of day or night, wherever they may be located. Former classmates can be kept engaged by building communities of story-sharing by college, major. The embodiments disclosed herein can create a direct channel between any organization and its remote users. Alumni communities exist in theory, but practically they are spread across the country and across the world. The embodiments disclosed herein can enable a streamlined way of managing content according to categories managed by the organization.

In the field of politics, in such that candidates and elected officials wish to engage with constituents on a wide range of issues, this Q&A tool provides a mass-personalized means of engagement at local, regional and national levels. The embodiments disclosed herein provide a way to express views on a variety of topics for the voter, candidate and elected official wherever they are located.

In the field of business ratings, such as that performed for restaurants, ratings come alive through the experience of food and atmosphere on video with first-hand real-time expressive reviews. For restaurant reviews, the embodiments disclosed herein allow users to see the food and feel the atmosphere using a direct communications channel.

In e-commerce, for example, consumer products such as make-up may be demonstrated, tested and endorsed in a tactical, sensate and practical manner. Testimonials collected may promote increased sales or the opportunity to reconfigure products. The embodiments disclosed herein allow the creation of direct channels for collecting demonstrations of individual products, promotions and sales as well as customer education and appreciation before purchase. Purchasing decisions may be streamlined through enabling a new, mass-personalized way of interaction between buyer and seller.

Conference and meeting networking can be continued through the face-to-face interaction long after conferences end. Through the embodiments disclosed herein, both before, during and after conferences, the experience may be anticipated, rated, and relationships maintained beyond the event.

Spectators at sporting events can leave personalized experiences as the spectacles unfold bring viewers a unique experience. Sporting events may be experienced in real-time remotely and on-site in personal ways like never before. The example dashboard of the embodiments disclosed herein can make curating volumes of video easy with the click of a mouse.

In the field of qualitative surveys, the embodiments disclosed herein allow for capturing and analyzing facial expressions and body language, and compilation of the information with cultural aspects that can provide researchers a wealth of additional data.

In the field of interviewing, the embodiments disclosed herein allow the creation of practice interviewing, which a user may participate in prior to conducting a “real” interview.

In the field of fund raising, the embodiments disclosed herein can recognize donors by asking them to record their motivation to give. These videos can be featured to motivate other alumni to give. The embodiments disclosed herein can be a catalyst tool behind donors and the project recipients. The embodiments disclosed herein can provide a tool to strengthen links between donor and recipient, as well as a synthesized way of maintaining a master database of video content by topic. Qualitative input can be measured against the cultural database.

In the field of education, the embodiments disclosed herein can energize online education programs by providing tailored feedback, collecting input from students in an organized manner through an interface. The embodiments disclosed herein can also set assignments, perform exam verification, record video profiles, video diaries, etc.

In an example embodiment, software for implementing at least a portion of the disclosed systems and methods can be stored as a computer program product, including, for example a non-transitory computer readable medium (e.g., a removable storage medium such as one or more DVD-ROM's, CD-ROM's, diskettes, and tapes) that provides at least a portion of the software instructions for the system. A computer program product can be installed by any suitable software installation procedure, as is well known in the art. In another embodiment, at least a portion of the software instructions may also be downloaded over a cable, communication and/or wireless connection. In other embodiments, the program can be a computer program propagated signal product embodied on a propagated signal on a propagation medium (e.g., a radio wave, an infrared wave, a laser wave, a sound wave, or an electrical wave propagated over a global network such as the Internet, or other network(s)). Such carrier medium or signals can provide at least a portion of the software instructions. In alternative embodiments, the propagated signal can be an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of a computer program product is a propagation medium that a computer system may receive and read, such as by receiving the propagation medium and identifying a propagated signal embodied in the propagation medium, as described above for computer program propagated signal product. Generally speaking, the term “carrier medium” or transient carrier encompasses the foregoing transient signals, propagated signals, propagated medium, storage medium and the like. In other embodiments, a program product may be implemented as Software as a Service (SaaS), or other installation or communication supporting end-users.

While example embodiments have been particularly shown and described, it will be understood by those skilled in the art that various changes in form and details may be made therein without departing from the scope of the embodiments encompassed by the appended claims.

What is claimed is:

1. A system for providing interactive collaboration over a computer network, the system comprising:
a content database configured to store digital content created by users;
an organizational database configured to store representations of relationships between the digital content stored in the content database and the users;
an interface configured to provide access to the digital content by other users and to enable the other users to provide feedback related to the digital content in a similar format as the digital content; and
a processor in communication with the databases and the interface, the processor configured to implement an intermediary layer between the databases and the interface, the intermediary layer configured to control which users can access the digital content, to store in the databases the feedback from the other users in a manner that is associated with the digital content, and to provide users with controlled access to the feedback.

2. A system as in claim 1 wherein the digital content and feedback are in a video, audio, and text format, a user accessing the content being enabled to provide feedback.

3. A system as in claim 1 further comprising a server hosting the databases and the interface, the interface including a website accessible by a uniform resource locator (URL) link.

4. A system as in claim 1 wherein the interface includes embedded code on one or more websites that are remote from the databases and used to create and generate the digital content, and wherein the organizational database includes one or more separate, but related, databases configured to track content linked to the embedded code.

5. A system as in claim 1 wherein the databases are relational database and the interface includes a website accessible by a uniform resource locator (URL) link and embedded code on one or more websites that are remote from the databases; and
wherein the feedback to the digital content is stored in the content database, and representations of relationships are stored in the organizational database in a manner associated with the digital content in a parent-child relationship, the representations of relationships being updated in real time, or asynchronously, simultaneously across each part of the interface.

6. A system as in claim 5 wherein the processor is configured to, when providing the digital content to the interface, access the databases to determine additional digital content that is feedback to the digital content and to provide to the interface the feedback along with the digital content. A system as in claim 6 wherein the interface is configured to present the digital content to a user along with one or more indications of the feedback.

8. A system for providing interactive collaboration, the system comprising:
a content database configured to store digital content created by users;
an organizational database configured to store representations of relationships between the digital content stored in the content database and the users;
an interface configured to provide access to the content by other users and to enable the other users to provide feedback to the content, the interface providing access via (i) a uniform resource locator (URL) link to a website associated with the organizational database or (ii) embedded code on a website that is remote from the URL used to create content or generate related embeddable code tracked by one or more organizational databases; and
a processor in communication with the databases and the interface, the processor configured to implement an intermediary layer between the databases and the interface, the intermediary layer configured to control which users can access the content, update content simultaneously across all parts of the interface, store the feedback in the databases in a parent-child relationship with the video content, and, when providing digital content to the interface, access one or more of the databases to determine additional content that is feedback to the content.

9. A system as in claim 8 wherein the interface is configured to display, in one screen view, video, audio, and text playback of the content and a plurality of indicators of related content that have been provided by other users as feedback to the content.

10. A system as in claim 9 wherein the interface is configured to display playback of a related video in response to user selection of a corresponding indicator.

11. A system as in claim 9 wherein the interface is configured to cause the intermediary layer to authenticate a user and to accept new content from the user as feedback to the content in response to selection of a reply indicator by the user.

12. A method of sourcing content, the method comprising:
enabling a user to create or deposit content by a subject person in connection with a given topic;
enabling the user to tailor parameters associated with distribution of the content, the parameters including at least an identifier of the subject person in the content and a distribution control indicator selectable to a given number of states, including a zero-distribution state;
enabling one or more other users to access and contribute to the content via a content collection and distribution channel by selection of the given topic or a different topic linked to the given topic; and
facilitating public or private distribution, disablement, or retraction of the content via the content collection and distribution channel as a function of at least the distribution control indicator.

13. The method of claim 12 wherein the parameters are stored separately from the content and the content is replicated across one or more content collection and distribution channels as a function of the distribution control indicator, and wherein the method further enables the user or subject person to modify the distribution control indicator to restrict further or open wider distribution to a subset of the multiple content collection and distribution channels or to disable or retract the content from one or more of the multiple content collection and distribution channels.

14. The method of claim 12 wherein the content collection and distribution channel includes a user-created relational database accessible by the other users, and wherein the method further comprises enabling a user or database manager to import the topic or define a related topic in the relational database in a manner that relates the content to the topic or related topic.

15. The method of claim 14 wherein the topic or related topic is a challenge, call-to-action, question, or related inquiries, and wherein the content is a video clip, multiple video clips, or multimedia that are associated with the inquiries based on a relationship with at least one inquiry, wherein the parameters include metadata through which the relational database creates the associations.

16. The method of claim 12 wherein enabling a user to create or deposit content includes duplicating the content at multiple datastore locations.

17. The method of claim 12 wherein enabling one or more other users to access and contribute to the content includes (i) providing a universal resource link to a web site associated with a datastore for the content, or (ii) embedding code on a website that is remote from the datastore including user-created content or user-generated related embeddable code and tracking content linked to the embedded code using separate, but related, databases.

18. The method of claim 12 wherein enabling one or more other users to access and contribute to the content includes challenging the one or more users to provide input regarding the topic.

19. The method of claim 12 wherein enabling one or more other users to access and contribute to the content includes engaging other users by sharing questions or themed challenges on social media.

20. The method of claim 12 further including analyzing amalgamated metadata based on the content created and deposited by one or more users, the amalgamated metadata including at least a topic identification or trending themes.

21. The method of claim 12 wherein enabling the user to tailor parameters associated with distribution of the content includes enabling the user to assign ownership of the content upon or before death of the user and provide instructions regarding distribution of the content after death of the user.
